(19) United States
(12) Patent Application Publication
(10) Pub. No.: US 2025/0175903 A1
(43) Pub. Date: May 29, 2025

(54) FEEDBACK FOR GROUPCAST TRANSMISSIONS IN PRESENCE OF ENERGY HARVESTING DEVICES

(71) Applicant: QUALCOMM Incorporated, San Diego, CA (US)

(72) Inventors: Kangqi LIU, San Diego, CA (US); Chao WEI, Beijing (CN); Ruiming ZHENG, Beijing (CN); Peter GAAL, San Diego, CA (US); Wanshi CHEN, San Diego, CA (US); Hao XU, Beijing (CN)

(21) Appl. No.: 18/840,893

(22) PCT Filed: Apr. 22, 2022
(86) PCT No.: PCT/CN2022/088484

§ 371 Date: Aug. 22, 2024

(51) Int. Cl. H04W 52/02; H02J 50/00; H04W 72/04; H04W 72/1263

(52) U.S. Cl. CPC H04W 52/0261; H02J 50/001; H04W 72/04; H04W 72/1263

(57) ABSTRACT

The apparatus may be a network node configured to measure at least one characteristic of an energy harvesting (EH) operation at the network node. The apparatus may further be configured to transmit information related to the at least one characteristic of the EH operation. The apparatus may also be configured to receive an allocation of resources for one of an UL transmission or a DL transmission scheduled based on the information related to the at least one characteristic of the EH operation. The apparatus may be a network entity configured to obtain information related to the at least one characteristic of an EH operation at a UE. The apparatus may further be configured to output an allocation of resources for one of an UL transmission or a DL transmission for the UE based on the information related to the at least one characteristic of the EH operation at the UE.

### TECHNICAL FIELD

The present disclosure relates generally to communication systems, and more particularly, to uplink (UL) and downlink (DL) scheduling for an energy harvesting user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE (e.g., a network node) configured to measure at least one characteristic of an energy harvesting operation at the UE. The apparatus may further be configured to transmit information related to the at least one characteristic of the energy harvesting operation. The apparatus may also be configured to receive an allocation of resources for one of an UL transmission or a DL transmission scheduled based on the information related to the at least one characteristic of the energy harvesting operation.

In an aspect of the disclosure, a method, a computer-readable medium, and an apparatus are provided. The apparatus may be a network entity configured to obtain information related to the at least one characteristic of an energy harvesting operation at a UE. The apparatus may further be configured to output an allocation of resources for one of an UL transmission or a DL transmission for the UE based on the information related to the at least one characteristic of the energy harvesting operation at the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a network node that may perform energy harvesting operations.

FIG. 5 is a call flow diagram illustrating an EH-capable UE in communication with a network node adjusting its operation based on a measured EH rate.

FIG. 6 is a set of diagrams illustrating a set of different ECHRs associated with different energy consumption rates and a same energy harvesting rate over a time period.

FIG. 7 is a call flow diagram illustrating an EH-capable UE in communication with a network node adjusting its operation based on a measured EH rate.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an apparatus and a network entity.

FIG. 12 is a diagram illustrating an example of a hardware implementation for a network entity.

### DETAILED DESCRIPTION

In some aspects of wireless communication, a network device may be capable of energy harvesting. However, the amount of energy harvested by a device may vary over time and the availability of energy may be intermittent. Accordingly, applications relying on harvested energy may not sustain continuous reception and/or transmission for extended periods of time. In accordance with aspects of the disclosure, an EH-capable device may adjust its operation based on an amount of harvested energy. The adjustment may be based on reporting EH characteristics that may be used to identify a maximum number of slots that may be scheduled to maintain energy levels (e.g., battery energy levels at the EH-capable device). In some aspects, the EH-capable device may adjust its operation to activate a power saving mode of operation. As described above, different reporting parameters/formats and power saving measures may be employed in accordance with aspects of this disclosure.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

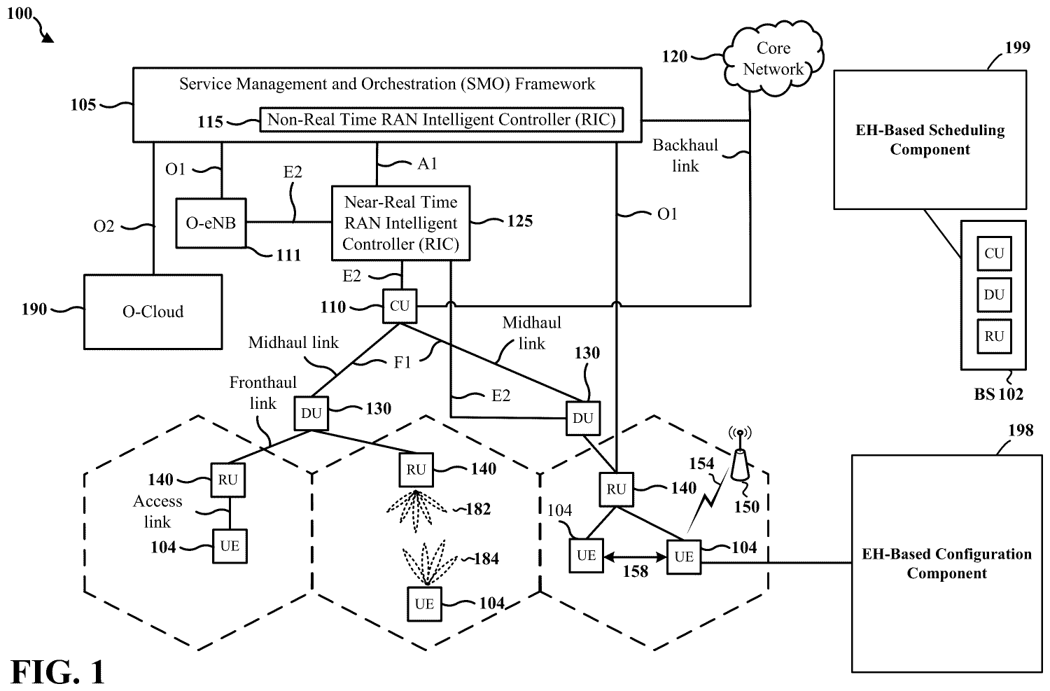

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an energy-harvesting-based (EH-based) configuration component 198 that may be configured to measure at least one characteristic of an energy harvesting operation at the UE, transmit information related to the at least one characteristic of the energy harvesting operation, and receive an allocation of resources for one of an UL transmission or a DL transmission scheduled based on the information related to the at least one characteristic of the energy harvesting operation. In certain aspects, the base station 102 may include an EH-based scheduling component 199 that may be configured to obtain information related to the at least one characteristic of an energy harvesting operation at a UE, and transmit an allocation of resources for one of an UL transmission or a DL transmission for the UE based on the information related to the at least one characteristic of the energy harvesting operation at the UE. Although the following description may be focused on 5G NR, the concepts described herein may be applicable to other similar areas, such as LTE, LTE-A, CDMA, GSM, and other wireless technologies.

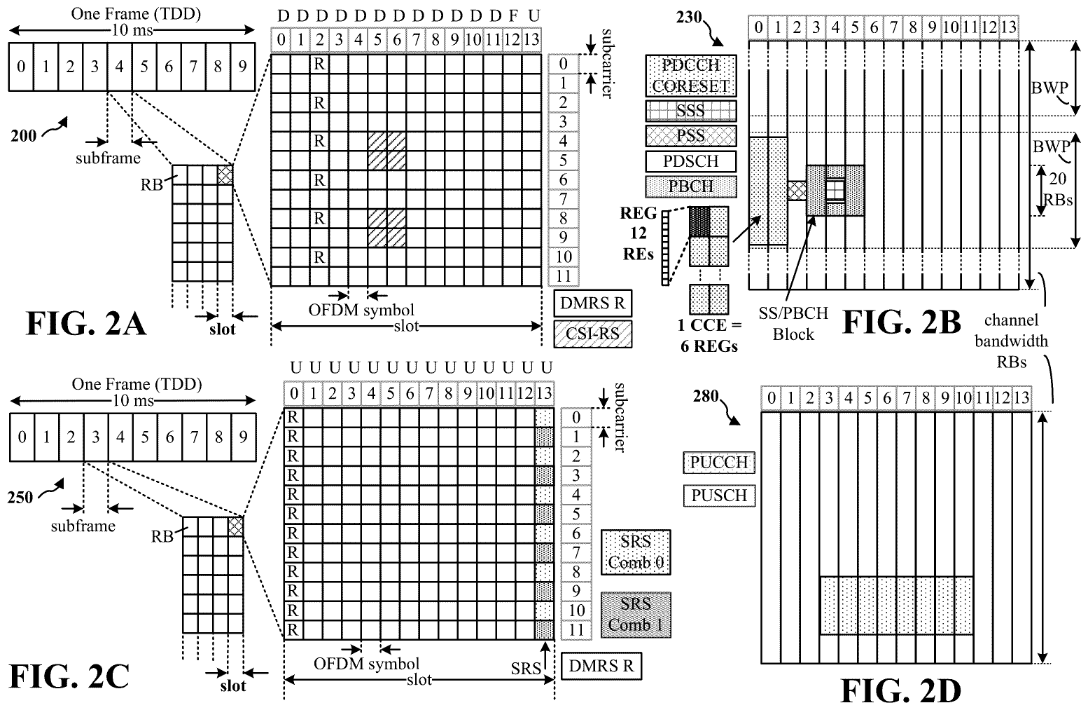

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

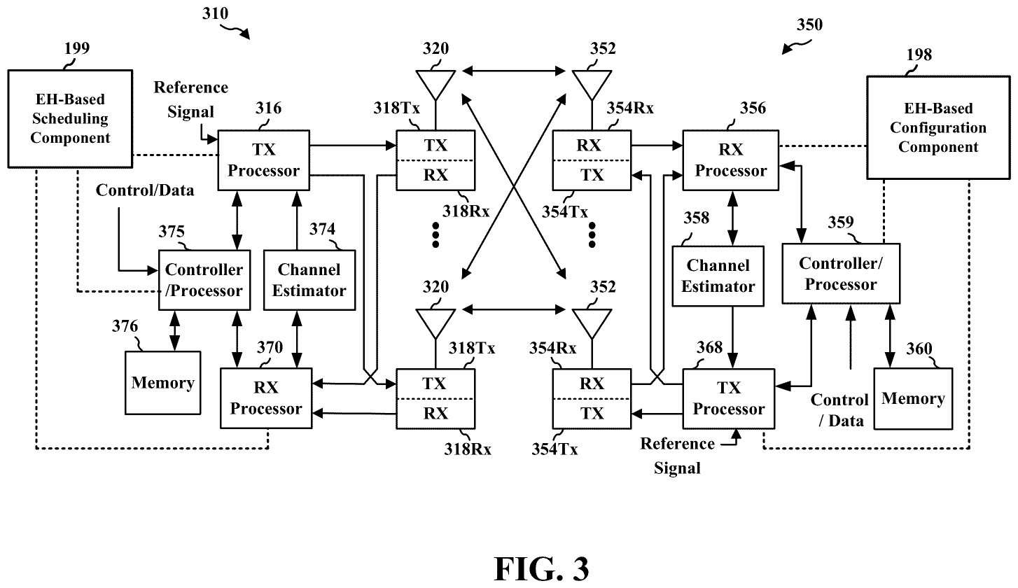

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the EH-based configuration component 198 of FIG. 1.

At least one of the TX processor 316, the RX processor 370, and the controller/processor 375 may be configured to perform aspects in connection with the EH-based scheduling component 199 of FIG. 1.

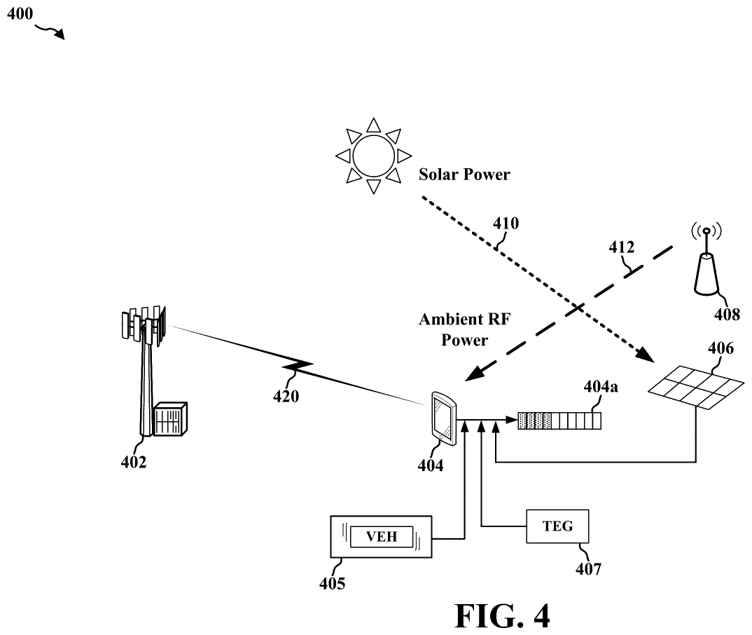

FIG. 4 is a diagram 400 illustrating a network node that may perform energy harvesting operations (e.g., an EH-capable network node). The EH-capable network node, in some aspects, may be a UE 404 that is associated with a battery 404a (e.g., an integrated battery). The UE 404 may harvest energy from ambient RF power 412 that may originate from a wireless transmitter 408. The UE 404 may also harvest energy via other devices or from other sources, such as solar power 410 via an outdoor an/or indoor photovoltaic module 406, vibrational energy harvesting module 405, and/or a thermal energy generator (TEG) 407. The UE 404 may be in communication with a network entity. The network entity may be a base station 402 and the communication may be via a wireless connection 420. In some aspects, the UE 404 may transmit information in an uplink signal to the base station 402 and may use a low power wake-up receiver (LP-WUR) or low power wake up signal (LP-WUS) receiver in downlink reception in order to reduce power consumption and to enable operation on intermittently harvested energy. The amount of energy harvested by a device may vary over time and the availability of energy may be intermittent. As well, the amount of communication traffic may vary over time. Accordingly, in some aspects, applications relying on harvested energy may not sustain continuous reception and/or transmission for extended periods of time. In some aspects, an EH-capable device may adjust its operation based on an amount of harvested energy. Whereas a passive internet of things (IoT) device (e.g., an RFID tag) may not have a battery and may collect ambient energy from an ambient RF signal in order to redirect the energy to an RFID reader, an EH powered device may include power consuming RF components for wireless communication, such as an Analog-to-Digital Converter (ADC), a mixer, oscillators, etc.

Aspects presented herein enable a device, such as a UE, operating in an EH mode to avoid consuming power that exceeds the harvested power in order to avoid running out of battery power. In some aspects, the device may communicate capability information to the network in order improve a balance between communication performance and energy harvesting.

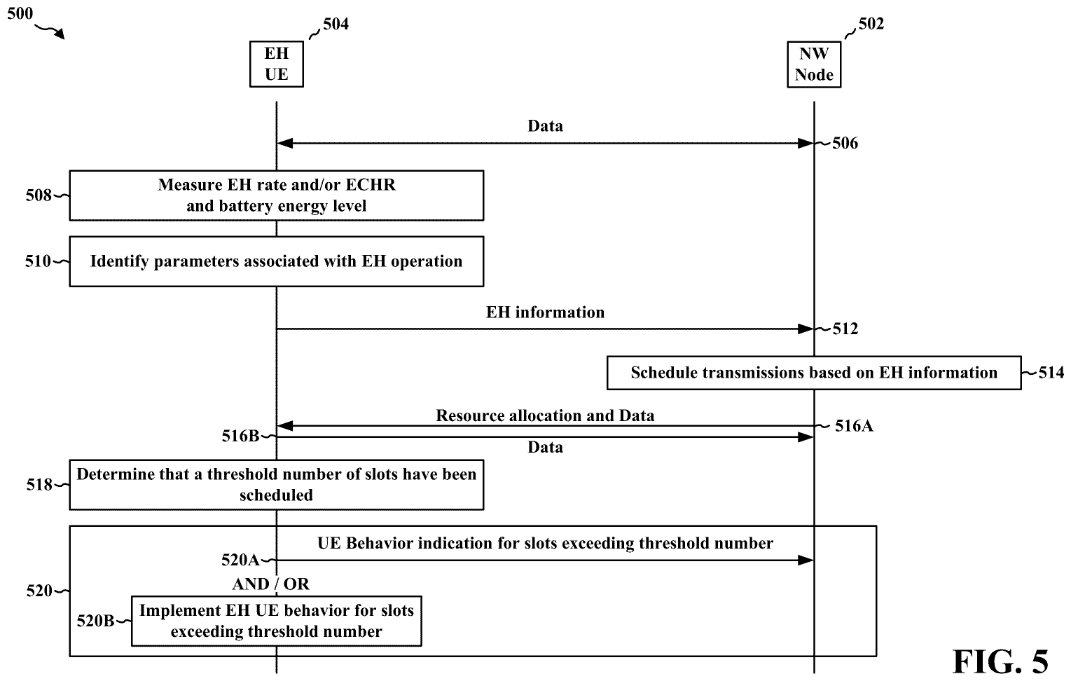

FIG. 5 is a call flow diagram 500 illustrating an EH-capable UE 504 in communication with a network (NW) node 502 adjusting its operation based on a measured EH rate. The EH UE 504 and the NW node 502 may exchange data 506 (e.g., via a first DL transmission from the network node 502 to the EH UE 504 and a UL transmission from the EH UE 504 to the NW node 502). At 508, the EH UE 504 may measure an EH rate (E_{HR}) and/or an energy consumption and harvesting ratio (ECHR) and a battery energy level. The ECHR may be based on a measured energy consumption rate (E_{CR}) associated with exchanging the data 506. The EH rate (E_{HR}) and energy consumption rate (E_{CR}) may be based on a measured harvested energy (E_{H}) and a measured energy consumption (E_{C}) measured over a time period (T), where

$$N = ⌊ M * \frac{γ}{δ} ⌋ .$$

An ECHR may then be defined as E_{CR}/E_{HR} and may reflect a net energy consumption (e.g., ECHR>1) or a net energy harvesting (e.g., ECHR<1).

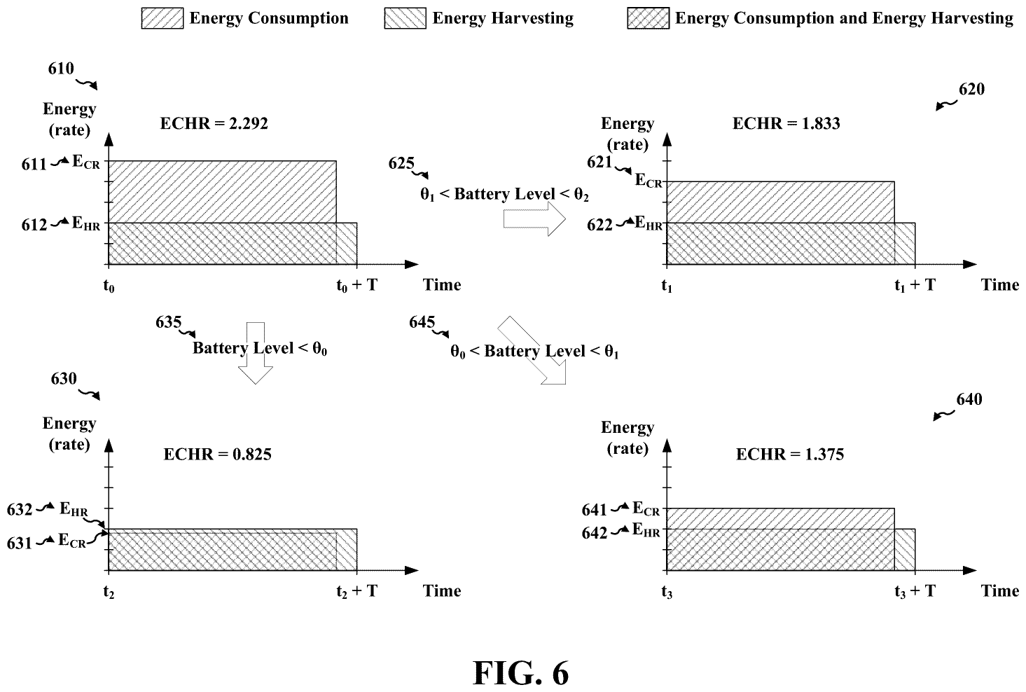

FIG. 6 is a set of diagrams 610-640 illustrating a set of different ECHRs associated with different energy consumption rates and a same energy harvesting rate over a time period T. For example, diagram 610 illustrates that during a time period [t₀, t₀+T] an energy consumption rate may exceed an energy harvesting rate. Similarly, diagrams 620 and 640 illustrate that during time periods [t₁, t₁+T] and [t₃, t₃+T], respectively, an energy consumption rate may exceed an energy harvesting rate by different amounts. Diagram 630 illustrates that during a time period [t₂, t₂+T] an energy harvesting rate may exceed an energy consumption rate and allow for continuous operation regardless of the battery energy level. The different ECHRs may be associated with different configurations of the EH UE 504 (e.g., different thresholds for maximum number of scheduled slots for UL and/or DL transmission/reception, different battery energy levels, etc.) as described below.

At 510, the EH UE 504 may identify parameters associated with the EH operation at the EH UE 504. The parameters may include the measured battery energy level and the EH rate and/or the ECHR. Identifying the parameters, in some aspects, may include identifying one of a measured harvested energy (e.g., E_{H}) or an EH rate (e.g., E_{HR}). In some aspects, a measurement period (e.g., T) is also identified, while in other aspects, the measurement period may be configured based on an indication from the NW node 502. The parameters, in some aspects, may include a maximum number of slots ‘N’ that can be scheduled in a period that may be the same as, or different from, the measurement period (e.g., T or T′) while maintaining an ECHR that is below a threshold value. In some aspects, the threshold ECHR value may be based on a measured battery energy level. For example, for an ultra-low battery energy level (e.g., a battery energy level that is below a first threshold, θ₀), a first threshold ECHR below 1 may be used, while for a very low and low battery energy levels (associated with thresholds θ₁ and θ₂, respectively) different threshold ECHR values (α and β, respectively) may be used, where 1≤α≤β.

The EH UE 504 may transmit, and the NW node 502 may receive, a transmission of EH information 512 based on the parameters identified at 510. The EH information 512, in some aspects, may include one of the measured harvested energy (e.g., E_{H}), the EH rate (e.g., E_{HR}), or the ECHR. In some aspects, the EH information 512 may include the measurement period (e.g., T), while in other aspects, the EH information 512 may not include the measurement period, e.g., when it is configured based on an indication from the NW node 502. The EH information 512, in some aspects, may also include an indication of the battery energy level. In some aspects, the EH information 512 may indicate the measured harvested energy (e.g., E_{H}), the EH rate (e.g., E_{HR}), the ECHR, the measurement period (e.g., T), or the battery energy level via an index into a list of indexed values. The units used in the EH information 512 to indicate the EH rate or the ECHR, in some aspects, may be an energy unit that may be defined, or based on, one of (1) an energy associated with transmitting x UL bits or (2) an energy associated with transmitting UL data in x REs, where x is a configured, or known, value. Accordingly, although the units may be different for each UE, the NW node may be able to more accurately determine the number of slots to schedule based on the reported energy units without maintaining information related to energy/bit or energy/RE for each UE.

In some aspects, EH information 512 may also include an indication of the maximum number of slots, N, that can be scheduled in a period (e.g., T or T′) while maintaining an ECHR that is below a threshold value. The indication, in some aspects, may include an indication of one of (1) the number of slots, N, and an associated time period, T′, in which the number of slots may be scheduled, (2) a ratio, N/T′, of the number of slots, N, that can be scheduled in the period, T′, while maintaining an ECHR that is below a threshold value divided by the period, T′, or (3) an indication of an adjustment to a previously indicated number of slots, N. In some aspects, a closed-loop procedure may be activated to determine the number of slots that can be in a period while maintaining an ECHR that is below a threshold value.

The EH information 512, in some aspect, may include an indication of the behavior of the EH UE 504 when a number of slots exceeding the maximum number of slots, N, are scheduled. The indicated behavior of the EH UE 504 may include disabling downlink control information (DCI) blind decoding. For example, the EH UE 504 may indicate that, after being ON for N slots in an associated time period, T, the EH UE 504 may not monitor PDCCH (e.g., by disabling DCI blind decoding). In some aspects, the indicated behavior of the EH UE 504 may include disabling UL transmissions and/or SRS transmissions, or disabling RS measurement and/or RS measurement reporting. In some aspects, the indication is not included in the EH information 512 and instead a UE behavior indication for slots exceeding the threshold number 520A is transmitted after detecting, at 518, that a number of slots exceeding the maximum number of slots, N, is scheduled.

Based on the EH information 512, the NW node 502 may schedule, at 514, a set of transmissions. The scheduled transmissions, in some aspects, may include DL transmissions and/or UL transmissions. If the EH information 512 did not include an indication of the maximum number of slots, N, that can be scheduled in a period while maintaining an ECHR that is below a threshold value, the NW node 502 may determine the maximum number of slots, N, based on, e.g., an ECHR and a battery energy level. For example, if the EH information 512 includes a first indication of a battery energy level and a second indication that for a first time period during which a number, M, of slots were scheduled a measured ECHR is a first value, the NW node 502 may determine a maximum number of slots, N, that may be scheduled for a second time period based on the measured ECHR and the indicated battery energy level. For example, the indicated battery energy level may correspond to an ECHR threshold value of y and the measured ECHR for M slots may be 8, and the maximum number of slots, N, that may be scheduled for the second time period may be calculated as

$${E}_{CR} = \frac{{E}_{C}}{T}$$

$$and$$

$${E}_{HR} = \frac{{E}_{H}}{T} .$$

Accordingly, the NW node 502 may schedule a number of slots that is at or below the maximum number of slots, N, that may be scheduled for the second time period.

FIG. 6 further illustrates a set of different ECHRs associated with different energy consumption rates and a same energy harvesting rate (e.g., E_{HR} 612, E_{HR} 622, E_{HR} 632, or E_{HR} 642) over a time period T that may be associated with different scheduled transmissions. For example, after receiving information (e.g., an ECHR and a battery energy level) associated with a first time period [t₀, t₀+T], the NW node may determine a number of configured slots (e.g., a number of slots associated with one of an E_{CR} 611, an E_{CR} 621, an E_{CR} 631, or an E_{CR} 641) for a subsequent time period (e.g., one of [t₁, t₁+T], [t₂, t₂+T], and [t₃, t₃+T]) to meet an ECHR threshold based on the battery level as illustrated by the transition 625, the transition 635, and the transition 645.

The NW node 502 may transmit, and the EH UE 504 may receive, an indication of the scheduled transmissions and scheduled DL transmissions via resource allocation and data 516A. The resource allocation and data 516A, in some aspects, includes an allocation of resources for one of an UL transmission (e.g., for data 516B transmitted by EH UE 504) or a DL transmission scheduled based on the information related to the at least one characteristic of the energy harvesting operation included in EH information 512. The indication of the scheduled transmission may be transmitted via one or more of an RRC transmission, a MAC control element (MAC-CE), or a DCI. The EH UE 504 may transmit, and the NW node 502 may receive, data 518 via scheduled UL transmissions.

Based on the received indication of the scheduled transmissions included in resource allocation and data 516A, the EH UE 504 may determine at 518 that a number of slots meeting or exceeding the maximum number of slots has been scheduled. The determination may be based on keeping track, at the EH UE, of scheduled slots during a measurement period and identifying when the threshold/maximum number of slots has been met or will be met (based on, e.g., DCI indicating an upcoming scheduled slot). After determining, at 518, that the number of slots meeting or exceeding the maximum number of slots has been scheduled and/or transmitted/received, the EH UE may, at 520, transmit, and NW node 502 may receive, a UE behavior indication for slots exceeding the threshold number 520A. In some aspects, at 520 the EH UE 504 may alternatively or additionally activate, at 520B, an EH UE behavior for slots exceeding the threshold number (e.g., as indicated in UE behavior indication for slots exceeding the threshold number 520A).

As discussed above, the (indicated) behavior of the EH UE 504 may include disabling DCI blind decoding. For example, the EH UE 504, after being ON for N slots in an associated time period, T, may not monitor PDCCH (e.g., by disabling DCI blind decoding). In some aspects, the (indicated) behavior of the EH UE 504 may include disabling UL transmissions and/or SRS transmissions, or disabling RS measurement and/or RS measurement reporting.

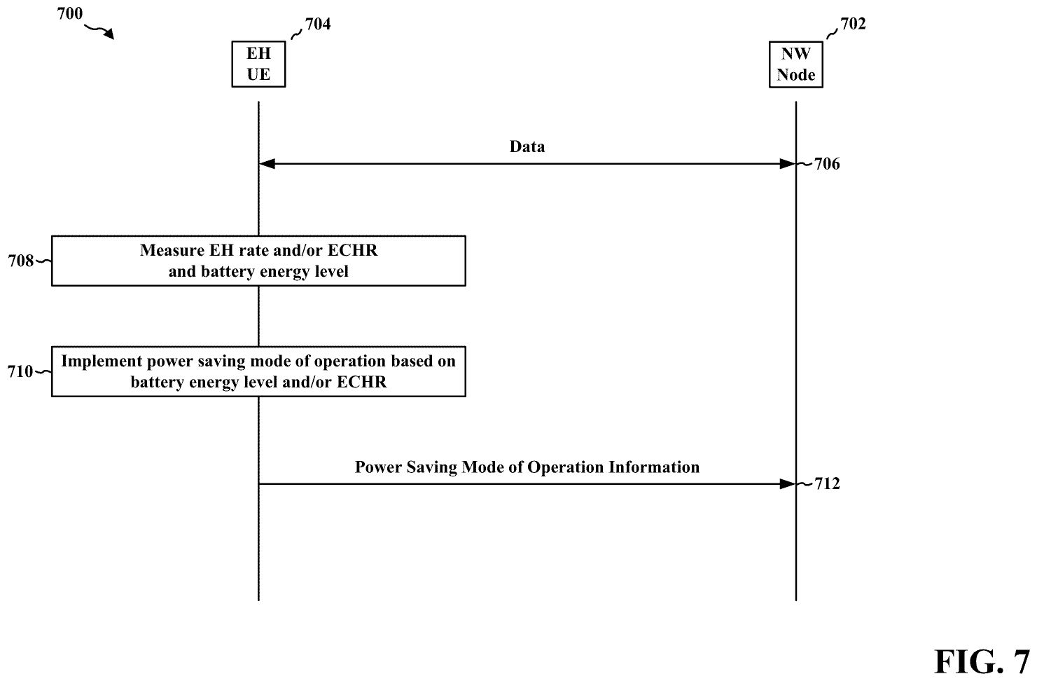

FIG. 7 is a call flow diagram 700 illustrating an EH-capable UE 704 in communication with a network (NW) node 702 adjusting its operation based on a measured EH rate. The EH UE 704 and the NW node 702 may exchange data 706 (e.g., via a first UL transmission from the network node 702 to the EH UE 704 and a DL transmission from the EH UE 704 to the NW node 702). At 708, the EH UE 704 may measure an EH rate (E_{HR}) and/or an energy consumption and harvesting ratio (ECHR) and a battery energy level. The ECHR may be based on a measured energy consumption rate (E_{CR}) associated with exchanging the data 706. The EH rate (E_{HR}) and energy consumption rate (E_{CR}) may be based on a measured harvested energy (E_{H}) and a measured energy consumption (E_{C}) measured over a time period (T), where

$${E}_{CR} = \frac{{E}_{C}}{T}$$

$$and$$

$${E}_{HR} = \frac{{E}_{H}}{T} .$$

An ECHR may then be defined as E_{CR}/E_{HR} and may reflect a net energy consumption (e.g., ECHR>1) or a net energy harvesting (e.g., ECHR<1).

At 710, the EH UE 704 may determine to activate a power saving mode of operation based on the measured battery energy level and a measured ECHR. For example, based on not meeting a first threshold battery energy level and an ECHR that exceeds an ECHR threshold value associated with the first threshold battery energy level, the EH UE 704 may activate a power saving mode of operation. As described above in relation to meeting a threshold ECHR value, different battery energy levels may be associated with different threshold ECHR values (e.g., given a first threshold battery energy that is lower than a second threshold battery energy, activating the power saving mode of operation may be triggered for the first threshold battery energy at a lower threshold ECHR value than the threshold ECHR value for the second threshold battery energy level).

The power saving mode of operation may include reducing the capacity of the EH UE 704 by transitioning to a reduced capacity (RedCap) mode of operation, transitioning from a full duplex mode of operation to a half duplex mode of operation, reducing one of a third number of MIMO or a fourth number of antenna panels associated with the wireless communication disabling dual connectivity, disabling carrier aggregation, and/or disabling MIMO. In some aspects, the power saving mode may include reducing resources allocated to communication with the NW node 702 by reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing a fifth number of neighboring cell measurements, and/or disabling periodic sounding reference signal and physical uplink control channel transmission. The power saving mode operation, in some aspects, may include additional modifications to the function of the EH UE 704.

The EH UE 704, in some aspects, may transmit, and NW node 702 may receive, power saving mode of operation information 712. Power saving mode of operation information 712, in some aspects, may include an indication of a set of capabilities of the EH UE 704 in the power saving mode of operation. The indication may be based on known UE capability sets (e.g., preconfigured, or known, capabilities of devices operating in a RedCap mode of operation). In some aspects, a set of capabilities may be indicated by explicit signaling related to aspects such as available bandwidth, number of antennas, etc. in accordance with a standard.

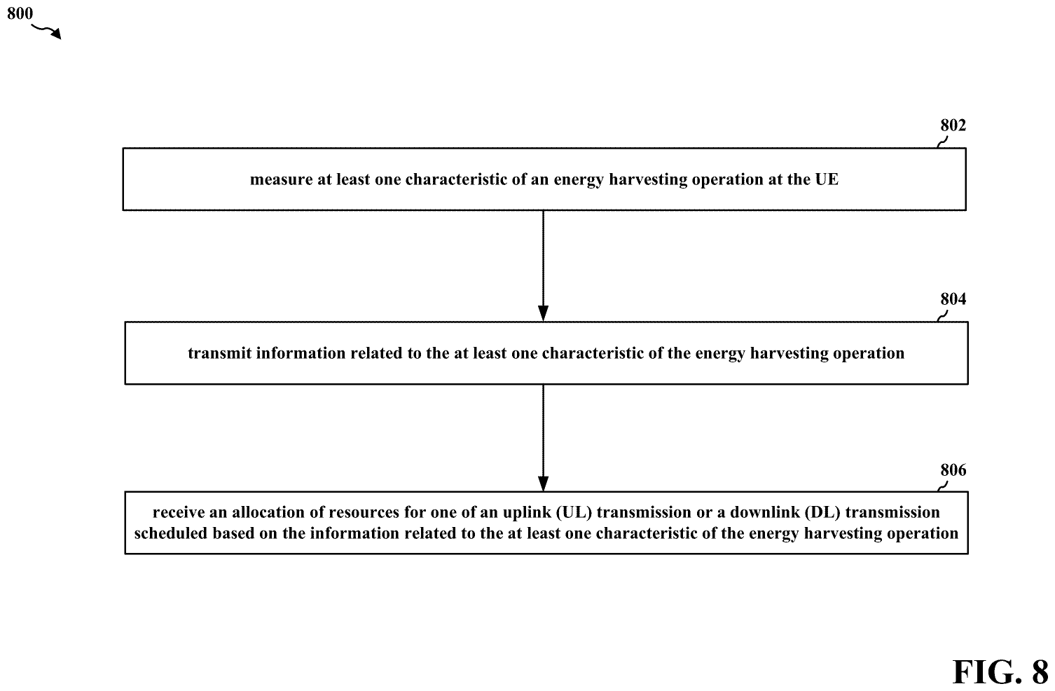

FIG. 8 is a flowchart 800 of a method of wireless communication. The method may be performed by a UE (e.g., the UE 104; the EH UE 504 or 704; the apparatus 1104). At 802, the UE may measure at least one characteristic of an energy harvesting operation at the UE. For example, 802 may be performed by EH-based configuration component 198. The at least one characteristic, in some aspects, may include one of a harvested energy power level or an energy harvesting rate over a time period. In some aspects, the time period is one of a first time period indicated in a transmission received at the UE or a second time period that may be included in information related to the at least one characteristic of the energy harvesting operation as discussed in relation to 804. The UE, at 802, may also measure a battery energy level. In some aspects, the at least one characteristic of the energy harvesting operation includes an ECHR based on an energy consumption rate and one of the harvested energy power level or the energy harvesting rate over the time period. For example, referring to FIGS. 5-7, the EH UE 504 or 704 may measure, at 508, or 708, an E_{HR} 612, 622, 632, or 642 and E_{CR} 611, 621, 631, or 641 over a time period T that may be associated with different scheduled transmissions.

Based on measuring, at 802, the at least one characteristic of the energy harvesting operation at the UE, the UE may determine a maximum number of slots that can be scheduled in a time period based on an ECHR threshold. In some aspects, based on a measured battery energy level and a measured ECHR, the UE may activate a power saving mode of operation. Activating the power saving mode of operation, in some aspects, may include transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, and/or disabling periodic sounding reference signal and physical uplink control channel transmission. For example, referring to FIGS. 6 and 7, the EH UE 704 may determine, at 710, to activate a power saving operation based on a measured battery energy level and one or more of an E_{HR} 612, 622, 632, or 642 and E_{CR} 611, 621, 631, or 641 over a time period T that may be used to calculate an ECHR.

At 804, the UE may transmit information related to the at least one characteristic of the energy harvesting operation. For example, 804 may be performed by EH-based configuration component 198. The information related to the at least one characteristic of the energy harvesting operation, in some aspects, includes a first indication of a maximum number of slots that can be scheduled in a time period based on an ECHR threshold. In some aspects, different ECHR thresholds are associated with different battery energy levels. The first indication of the maximum number of slots that can be scheduled in the time period, in some aspects, indicates a change in a previously-indicated maximum number of slots. In some aspects, the information related to the at least one characteristic of the energy harvesting operation includes a second indication of a behavior of the UE during time periods for which a received allocation of a number of slots in the time period exceeds the maximum number of slots that can be scheduled in the time period. The behavior of the UE indicated by the second indication, in some aspects, includes one or more of disabling DCI blind decoding, disabling UL transmissions, and/or disabling RS measurement and RS measurement reporting. The second indication may be included in the information related to the at least one characteristic of the energy harvesting operation in response to a received allocation of the number of slots in the time period exceeding the maximum number of slots that can be scheduled in the time period. For example, referring to FIGS. 5 and 6, the EH UE 504 may transmit, and the NW node 502 may receive, EH information 512 related to at least one characteristic of the energy harvesting operation such as an E_{HR} 612, 622, 632, or 642 and/or E_{CR} 611, 621, 631, or 641 over a time period T.

In some aspects, the information related to the at least one characteristic of the energy harvesting operation includes an index value indicating a value in an indexed set of values for one of a harvested energy power level, an energy harvesting rate, a period of time, a battery energy level at the UE, or an ECHR. The information related to the at least one characteristic of the energy harvesting operation, in some aspects, includes one of a harvested energy power level or an energy harvesting rate over a time period expressed in terms of an energy unit associated with an UL transmission. In some aspects, the energy unit is based on one of a first amount of energy consumed to transmit a first number of bits or a second amount of energy consumed to transmit UL data in a second number of resource elements. For example, referring to FIGS. 5 and 6, the EH UE 504 may transmit, and the NW node 502 may receive, EH information 512 based on a set of indexed values associated with the at least one characteristic of the energy harvesting operation such as an E_{HR} 612, 622, 632, or 642 and/or E_{CR} 611, 621, 631, or 641 over a time period T.

The information related to the at least one characteristic of the energy harvesting operation, in some aspects, may include an indication that the UE will activate a power saving mode of operation. The indication that the UE will activate the power saving mode of operation, in some aspects, includes an indication of the adjustments included in activating the power saving mode of operation. In some aspects, the indicated adjustments may include one or more of transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, and/or disabling periodic sounding reference signal and physical uplink control channel transmission. For example, referring to FIG. 7, the EH UE 704 may transmit, and the NW node 702 may receive, power saving mode of operation information 712.

Finally, at 806, the UE may receive an allocation of resources for one of an UL transmission or a DL transmission scheduled based on the information related to the at least one characteristic of the energy harvesting operation. For example, 806 may be performed by EH-based configuration component 198. In some aspects, a second indication of a behavior of the UE during time periods for which a received allocation of a number of slots in the time period exceeds the maximum number of slots that can be scheduled in the time period is transmitted in response to the received allocation of the number of slots in the time period exceeding the maximum number of slots that can be scheduled in the time period. For example, referring to FIGS. 5 and 6, the NW node 502 may transmit, and the EH UE 504 may receive, resource allocation and data 516A including an allocation of resources for one of an UL transmission or a DL transmission scheduled based on the information related to the at least one characteristic of the energy harvesting operation.

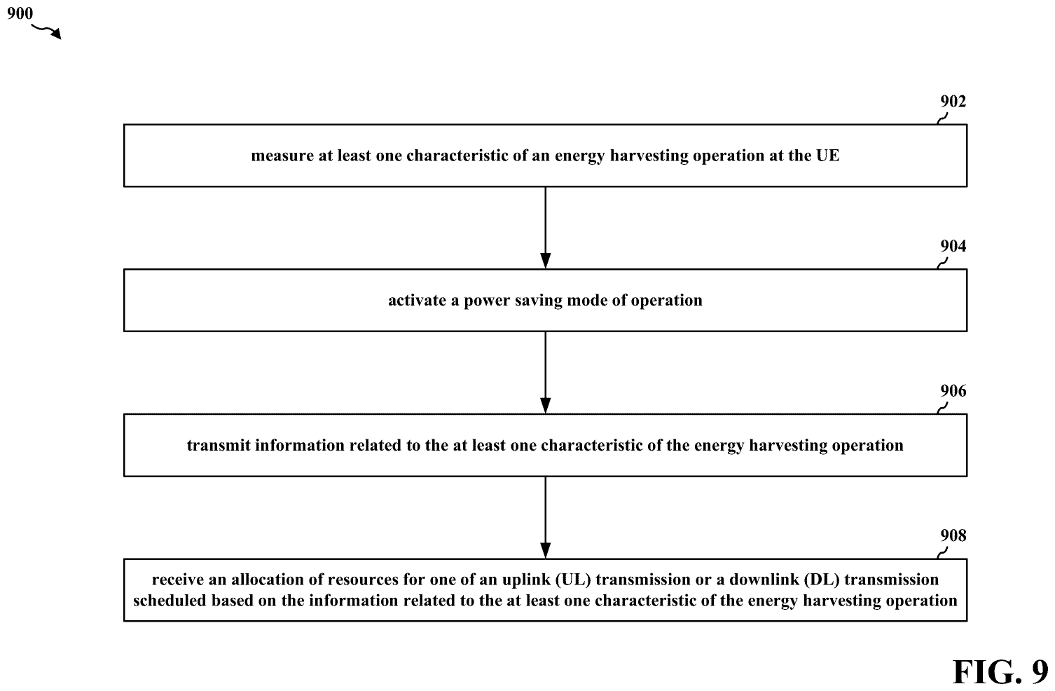

FIG. 9 is a flowchart 900 of a method of wireless communication. The method may be performed by a UE (e.g., the UE 104; the EH UE 504 or 704; the apparatus 1104). At 902, the UE may measure at least one characteristic of an energy harvesting operation at the UE. For example, 902 may be performed by EH-based configuration component 198. The at least one characteristic, in some aspects, may include one of a harvested energy power level or an energy harvesting rate over a time period. In some aspects, the time period is one of a first time period indicated in a transmission received at the UE or a second time period that may be included in information related to the at least one characteristic of the energy harvesting operation as discussed in relation to 904. The UE, at 902, may also measure a battery energy level. In some aspects, the at least one characteristic of the energy harvesting operation includes an ECHR based on an energy consumption rate and one of the harvested energy power level or the energy harvesting rate over the time period. For example, referring to FIGS. 5-7, the EH UE 504 or 704 may measure, at 508, or 708, an E_{HR} 612, 622, 632, or 642 and E_{CR} 611, 621, 631, or 641 over a time period T that may be associated with different scheduled transmissions.

In some aspects, based on a measured battery energy level and a measured ECHR, the UE may, at 904, activate a power saving mode of operation. For example, 904 may be performed by EH-based configuration component 198. Activating the power saving mode of operation, in some aspects, may include transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, and/or disabling periodic sounding reference signal and physical uplink control channel transmission. For example, referring to FIGS. 6 and 7, the EH UE 704 may determine, at 710, to activate a power saving operation based on a measured battery energy level and one or more of an E_{HR} 612, 622, 632, or 642 and E_{CR} 611, 621, 631, or 641 over a time period T that may be used to calculate an ECHR.

Based on measuring, at 902, the at least one characteristic of the energy harvesting operation at the UE, the UE may determine a maximum number of slots that can be scheduled in a time period based on an ECHR threshold. At 906, the UE may transmit information related to the at least one characteristic of the energy harvesting operation. For example, 906 may be performed by EH-based configuration component 198. The information related to the at least one characteristic of the energy harvesting operation, in some aspects, includes a first indication of a maximum number of slots that can be scheduled in a time period based on an ECHR threshold. In some aspects, different ECHR thresholds are associated with different battery energy levels. The first indication of the maximum number of slots that can be scheduled in the time period, in some aspects, indicates a change in a previously-indicated maximum number of slots. In some aspects, the information related to the at least one characteristic of the energy harvesting operation includes a second indication of a behavior of the UE during time periods for which a received allocation of a number of slots in the time period exceeds the maximum number of slots that can be scheduled in the time period. The behavior of the UE indicated by the second indication, in some aspects, includes one or more of disabling DCI blind decoding, disabling UL transmissions, and/or disabling RS measurement and RS measurement reporting. The second indication may be included in the information related to the at least one characteristic of the energy harvesting operation in response to a received allocation of the number of slots in the time period exceeding the maximum number of slots that can be scheduled in the time period. For example, referring to FIGS. 5 and 6, the EH UE 504 may transmit, and the NW node 502 may receive, EH information 512 related to at least one characteristic of the energy harvesting operation such as an E_{HR} 612, 622, 632, or 642 and/or E_{CR} 611, 621, 631, or 641 over a time period T.

In some aspects, the information related to the at least one characteristic of the energy harvesting operation includes an index value indicating a value in an indexed set of values for one of a harvested energy power level, an energy harvesting rate, a period of time, a battery energy level at the UE, or an ECHR. The information related to the at least one characteristic of the energy harvesting operation, in some aspects, includes one of a harvested energy power level or an energy harvesting rate over a time period expressed in terms of an energy unit associated with an UL transmission. In some aspects, the energy unit is based on one of a first amount of energy consumed to transmit a first number of bits or a second amount of energy consumed to transmit UL data in a second number of resource elements. For example, referring to FIGS. 5 and 6, the EH UE 504 may transmit, and the NW node 502 may receive, EH information 512 based on a set of indexed values associated with the at least one characteristic of the energy harvesting operation such as an E_{HR} 612, 622, 632, or 642 and/or E_{CR} 611, 621, 631, or 641 over a time period T.

The information related to the at least one characteristic of the energy harvesting operation, in some aspects, may include an indication that the UE will activate a power saving mode of operation. The indication that the UE will activate the power saving mode of operation, in some aspects, includes an indication of the adjustments included in activating the power saving mode of operation. In some aspects, the indicated adjustments may include one or more of transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, and/or disabling periodic sounding reference signal and physical uplink control channel transmission. For example, referring to FIG. 7, the EH UE 704 may transmit, and the NW node 702 may receive, power saving mode of operation information 712.

Finally, at 908, the UE may receive an allocation of resources for one of an UL transmission or a DL transmission scheduled based on the information related to the at least one characteristic of the energy harvesting operation. For example, 906 may be performed by EH-based configuration component 198. In some aspects, a second indication of a behavior of the UE during time periods for which a received allocation of a number of slots in the time period exceeds the maximum number of slots that can be scheduled in the time period is transmitted in response to the received allocation of the number of slots in the time period exceeding the maximum number of slots that can be scheduled in the time period. For example, referring to FIGS. 5 and 6, the NW node 502 may transmit, and the EH UE 504 may receive, resource allocation and data 516A including an allocation of resources for one of an UL transmission or a DL transmission scheduled based on the information related to the at least one characteristic of the energy harvesting operation.

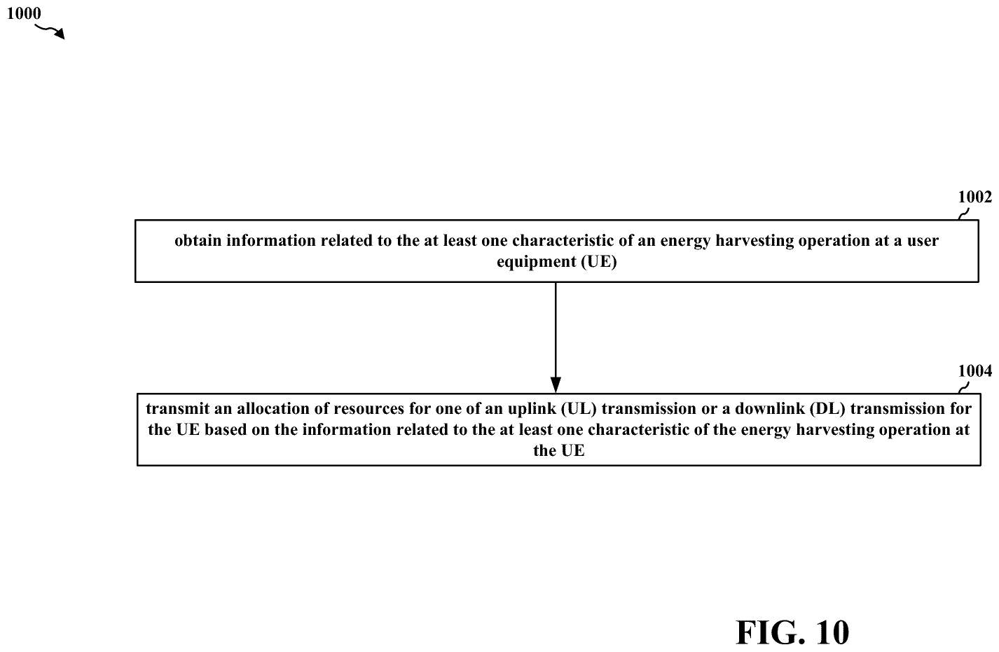

FIG. 10 is a flowchart 1000 of a method of wireless communication. The method may be performed by a network node (e.g., the base station 102; the NW node 502 or 702; the network entity 1102). At 1002, the network node may obtain information related to at least one characteristic of an energy harvesting operation at a UE. For example, 1002 may be performed by EH-based scheduling component 199. The at least one characteristic, in some aspects, may include one of a harvested energy power level or an energy harvesting rate over a time period. In some aspects, the time period is one of a first time period indicated in a transmission received at the UE or a second time period that may be included in the information related to the at least one characteristic of the energy harvesting operation. The information related to the at least one characteristic of the energy harvesting operation may also include a battery energy level. In some aspects, the at least one characteristic of the energy harvesting operation includes an ECHR based on an energy consumption rate and one of the harvested energy power level or the energy harvesting rate over the time period. For example, referring to FIGS. 5-7, the NW node 502 or 702 may obtain EH information 512 including information related to an E_{HR} 612, 622, 632, or 642 and E_{CR} 611, 621, 631, or 641 over a time period T.

Based on measuring, at 1002, the at least one characteristic of the energy harvesting operation at the UE, the UE may determine a maximum number of slots that can be scheduled in a time period based on an ECHR threshold. The information related to the at least one characteristic of the energy harvesting operation, in some aspects, includes a first indication of a maximum number of slots that can be scheduled in a time period based on an ECHR threshold. In some aspects, different ECHR thresholds are associated with different battery energy levels. The first indication of the maximum number of slots that can be scheduled in the time period, in some aspects, indicates a change in a previously-indicated maximum number of slots. In some aspects, the information related to the at least one characteristic of the energy harvesting operation includes a second indication of a behavior of the UE during time periods for which a received allocation of a number of slots in the time period exceeds the maximum number of slots that can be scheduled in the time period. The behavior of the UE indicated by the second indication, in some aspects, includes one or more of disabling DCI blind decoding, disabling UL transmissions, and/or disabling RS measurement and RS measurement reporting. The second indication may be included in the information related to the at least one characteristic of the energy harvesting operation in response to a received allocation of the number of slots in the time period exceeding the maximum number of slots that can be scheduled in the time period.

In some aspects, the information related to the at least one characteristic of the energy harvesting operation includes an index value indicating a value in an indexed set of values for one of a harvested energy power level, an energy harvesting rate, a period of time, a battery energy level at the UE, or an ECHR. The information related to the at least one characteristic of the energy harvesting operation, in some aspects, includes one of a harvested energy power level or an energy harvesting rate over a time period expressed in terms of an energy unit associated with an UL transmission. In some aspects, the energy unit is based on one of a first amount of energy consumed to transmit a first number of bits or a second amount of energy consumed to transmit UL data in a second number of resource elements. For example, referring to FIGS. 5 and 6, the EH UE 504 may transmit, and the NW node 502 may receive, EH information 512 based on a set of indexed values associated with the at least one characteristic of the energy harvesting operation such as an E_{HR} 612, 622, 632, or 642 and/or E_{CR} 611, 621, 631, or 641 over a time period T.

The information related to the at least one characteristic of the energy harvesting operation, in some aspects, may include an indication that the UE will activate a power saving mode of operation. The indication that the UE will activate the power saving mode of operation, in some aspects, includes an indication of the adjustments included in activating the power saving mode of operation. In some aspects, the indicated adjustments may include one or more of transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, and/or disabling periodic sounding reference signal and physical uplink control channel transmission. For example, referring to FIG. 7, the EH UE 704 may transmit, and the NW node 702 may receive, power saving mode of operation information 712.

Finally, at 1004, the network node may transmit an allocation of resources for one of an UL transmission or a DL transmission scheduled based on the information related to the at least one characteristic of the energy harvesting operation. For example, 1004 may be performed by EH-based scheduling component 199. For example, referring to FIGS. 5 and 6, the NW node 502 may transmit, and the EH UE 504 may receive, resource allocation and data 516A including an allocation of resources for one of an UL transmission or a DL transmission scheduled based on the information related to the at least one characteristic of the energy harvesting operation.

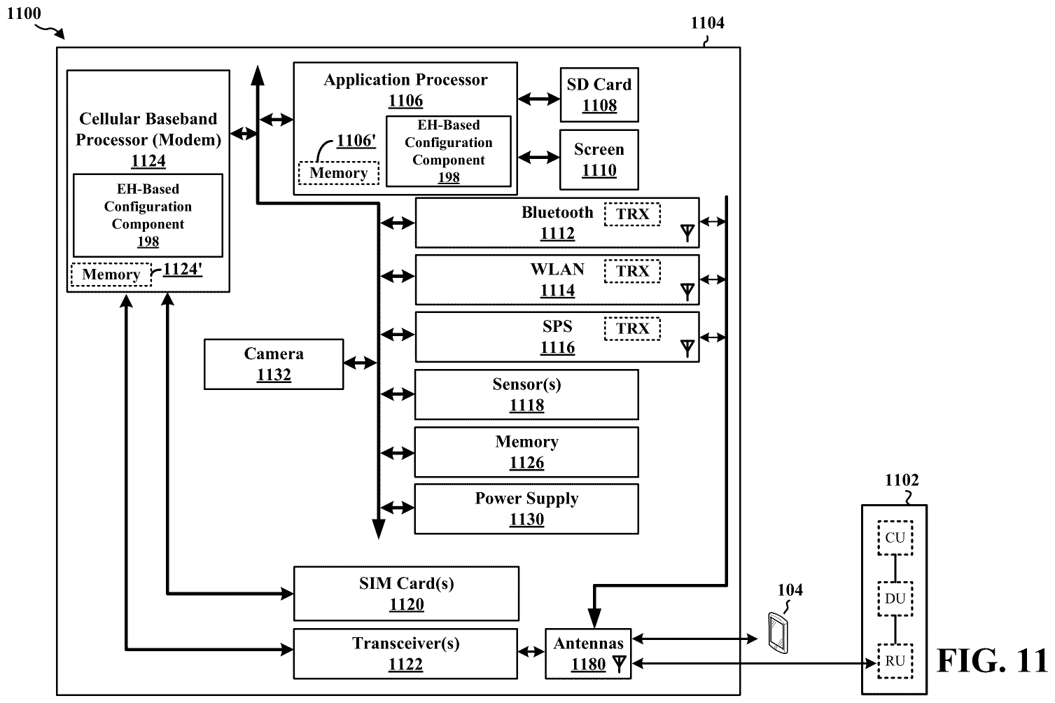

FIG. 11 is a diagram 1100 illustrating an example of a hardware implementation for an apparatus 1104. The apparatus 1104 may be a UE, a component of a UE, or may implement UE functionality. In some aspects, the apparatus1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to measure at least one characteristic of an energy harvesting operation at the UE, transmit information related to the at least one characteristic of the energy harvesting operation, and receive an allocation of resources for one of an UL transmission or a DL transmission scheduled based on the information related to the at least one characteristic of the energy harvesting operation. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for measuring at least one characteristic of an energy harvesting operation at the UE, transmitting information related to the at least one characteristic of the energy harvesting operation, receiving an allocation of resources for one of an UL transmission or a DL transmission scheduled based on the information related to the at least one characteristic of the energy harvesting operation, and activating a power saving mode of operation when at least one of a battery energy level at the UE is below a threshold energy level or a ECHR is above a threshold value. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

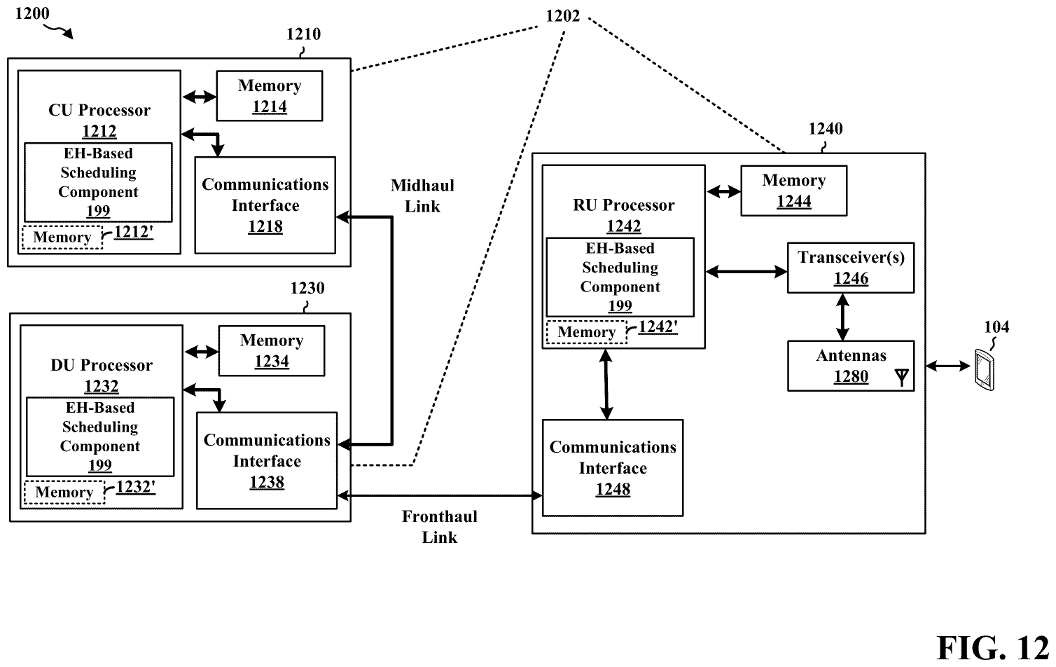

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to obtain information related to the at least one characteristic of an energy harvesting operation at a UE, and transmit an allocation of resources for one of an UL transmission or a DL transmission for the UE based on the information related to the at least one characteristic of the energy harvesting operation at the UE. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for obtaining information related to the at least one characteristic of an energy harvesting operation at a UE, and transmitting an allocation of resources for one of an UL transmission or a DL transmission for the UE based on the information related to the at least one characteristic of the energy harvesting operation at the UE. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, a network device may be capable of energy harvesting. However, the amount of energy harvested by a device may vary over time and the availability of energy may be intermittent. Accordingly, applications relying on harvested energy may not sustain continuous reception and/or transmission for extended periods of time. In accordance with aspects of the disclosure, an EH-capable device may adjust its operation based on an amount of harvested energy. The adjustment may be based on reporting EH characteristics that may be used to identify a maximum number of slots that may be scheduled to maintain energy levels (e.g., battery energy levels at the EH-capable device). In some aspects, the EH-capable device may adjust its operation to activate a power saving mode of operation. AS described above, different reporting parameters/formats and power saving measures may be employed in accordance with aspects of this disclosure.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method of wireless communication at a UE operating in an energy harvesting mode, the method including measuring at least one characteristic of an energy harvesting operation at the UE, transmitting information related to the at least one characteristic of the energy harvesting operation, and receiving an allocation of resources for one of an UL transmission or a DL transmission scheduled based on the information related to the at least one characteristic of the energy harvesting operation.

Aspect 2 is the method of aspect 1, where the at least one characteristic includes one of a harvested energy power level or an energy harvesting rate over a time period.

Aspect 3 is the method of aspect 2, where the time period is one of a first time period indicated in a transmission received at the UE or a second time period included in the information related to the at least one characteristic of the energy harvesting operation.

Aspect 4 is the method of any of aspects 2 to 3, where the information related to the at least one characteristic of the energy harvesting operation further includes a battery energy level at the UE.

Aspect 5 is the method of any of aspects 2 to 4, where the at least one characteristic of the energy harvesting operation includes an ECHR based on an energy consumption rate and one of the harvested energy power level or the energy harvesting rate over the time period.

Aspect 6 is the method of any of aspects 1 to 5, where the information related to the at least one characteristic of the energy harvesting operation includes a first indication of a maximum number of slots that can be scheduled in a time period based on an ECHR threshold.

Aspect 7 is the method of aspect 6, where different ECHR thresholds are associated with different battery energy levels.

Aspect 8 is the method of any of aspects 6 and 7, where the first indication of the maximum number of slots that can be scheduled in the time period indicates a change in a previously-indicated maximum number of slots.

Aspect 9 is the method of any of aspects 6 to 8, the information related to the at least one characteristic of the energy harvesting operation includes a second indication of a behavior of the UE during time periods for which a received allocation of a number of slots in the time period exceeds the maximum number of slots that can be scheduled in the time period, and where the behavior of the UE includes one or more of disabling DCI blind decoding, disabling UL transmissions, or disabling RS measurement and RS measurement reporting.

Aspect 10 is the method of aspect 9, where the second indication is included in the information related to the at least one characteristic of the energy harvesting operation in response to the received allocation of the number of slots in the time period exceeding the maximum number of slots that can be scheduled in the time period.

Aspect 11 is the method of any of aspects 1 to 10 further including activating a power saving mode of operation when at least one of: a battery energy level at the UE is below a threshold energy level or the ECHR is above a threshold value.

Aspect 12 is the method of aspect 11, where activating the power saving mode of operation includes one or more of: transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, or disabling periodic sounding reference signal and physical uplink control channel transmission.

Aspect 13 is the method of any of aspects 1 to 12, where the information related to the at least one characteristic of the energy harvesting operation includes an index value indicating a value in an indexed set of values for one of a harvested energy power level, an energy harvesting rate, a period of time, a battery energy level at the UE, or an ECHR.

Aspect 14 is the method of any of aspects 1 to 13, where the information related to the at least one characteristic of the energy harvesting operation includes one of a harvested energy power level or an energy harvesting rate over a time period expressed in terms of an energy unit associated with an UL transmission.

Aspect 15 is the method of aspect 14, where the energy unit is based on one of a first amount of energy consumed to transmit a first number of bits or a second amount of energy consumed to transmit UL data in a second number of resource elements.

Aspect 16 is a method of wireless communication at a network entity, the method including obtaining information related to at least one characteristic of an energy harvesting operation at a UE and transmitting an allocation of resources for one of an UL transmission or a DL transmission for the UE based on the information related to the at least one characteristic of the energy harvesting operation at the UE.

Aspect 17 is the method of aspect 16, where the at least one characteristic includes one of a harvested energy power level or an energy harvesting rate over a time period.

Aspect 18 is the method of aspect 17, where the time period is one of a first time period indicated in a transmission received at the UE or a second time period included in the information related to the at least one characteristic of the energy harvesting operation.

Aspect 19 is the method of any of aspects 17 to 18, where the information related to the at least one characteristic of the energy harvesting operation further includes a battery energy level at the UE.

Aspect 20 is the method of any of aspects 17 to 19, where the at least one characteristic of the energy harvesting operation includes an ECHR based on an energy consumption rate and one of the harvested energy power level or the energy harvesting rate over the time period.

Aspect 21 is the method of any of aspects 16 to 20, where the information related to the at least one characteristic of the energy harvesting operation includes a first indication of a maximum number of slots that can be scheduled in a time period based on an ECHR threshold.

Aspect 22 is the method of aspect 21, where different ECHR thresholds are associated with different battery energy levels.

Aspect 23 is the method of any of aspects 21 and 22, where the first indication of the maximum number of slots that can be scheduled in the time period indicates a change in a previously-indicated maximum number of slots.

Aspect 24 is the method of any of aspects 21 to 23, the information related to the at least one characteristic of the energy harvesting operation includes a second indication of a behavior of the UE during time periods for which a received allocation of a number of slots in the time period exceeds the maximum number of slots that can be scheduled in the time period, and where the behavior of the UE includes one or more of disabling DCI blind decoding, disabling UL transmissions, or disabling RS measurement and RS measurement reporting.

Aspect 25 is the method of aspect 24, where the second indication is included in the information related to the at least one characteristic of the energy harvesting operation in response to the received allocation of the number of slots in the time period exceeding the maximum number of slots that can be scheduled in the time period.

Aspect 26 is the method of any of aspects 1 to 10, where the information related to the at least one characteristic of the energy harvesting operation at the UE indicates for the network entity to communicate with the UE in a power saving mode of operation, and where the information related to the at least one characteristic of the energy harvesting operation at the UE includes at least one of a battery energy level at the UE being below a threshold energy level, the ECHR being above a threshold value, or an indication of a power saving mode of operation being activated at the UE.

Aspect 27 is the method of aspect 26, where the power saving mode of operation includes one or more of the UE: transitioning to a RedCap mode of operation, transitioning from a full duplex mode of operation to a half duplex mode of operation, reducing physical downlink control channel monitoring, increasing a period between periodic transmissions, disabling non-slot-based scheduling, reducing at least one of a first number of resources in a frequency domain or a second number of resources in a time domain associated with a channel measurement operation, reducing one of a third number of MIMO or a fourth number of antenna panels associated with the wireless communication, disabling dual connectivity, disabling carrier aggregation, disabling MIMO, reducing a fifth number of neighboring cell measurements, or disabling periodic sounding reference signal and physical uplink control channel transmission.

Aspect 28 is the method of any of aspects 16 to 27, where the information related to the at least one characteristic of the energy harvesting operation includes an index value indicating a value in an indexed set of values for one of a harvested energy power level, an energy harvesting rate, a period of time, a battery energy level at the UE, or an ECHR.

Aspect 29 is the method of any of aspects 16 to 28, where the information related to the at least one characteristic of the energy harvesting operation includes one of a harvested energy power level or an energy harvesting rate over a time period expressed in terms of an energy unit associated with an UL transmission.

Aspect 30 is the method of aspect 29, where the energy unit is based on one of a first amount of energy consumed to transmit a first number of bits or a second amount of energy consumed to transmit UL data in a second number of resource elements.

Aspect 31 is an apparatus including memory and at least one processor coupled to the memory and configured to perform the method of any of aspects 1 to 30.

Aspect 32 is an apparatus for wireless communication including means for implementing any of aspects 1 to 30.

Aspect 33 is a computer-readable medium storing computer executable code, where the code when executed by a processor causes the processor to implement any of aspects 1 to 30.

What is claimed is:

1. An apparatus for wireless communication at a user equipment (UE) operating in an energy harvesting mode, comprising:
a memory; and
at least one processor coupled to the memory and, based at least in part on data stored in the memory, the at least one processor is configured to:
measure at least one characteristic of an energy harvesting operation at the UE;
transmit information related to the at least one characteristic of the energy harvesting operation; and
receive an allocation of resources for one of an uplink (UL) transmission or a downlink (DL) transmission scheduled based on the information related to the at least one characteristic of the energy harvesting operation.

2. The apparatus of claim 1, wherein the at least one characteristic comprises one of a harvested energy power level or an energy harvesting rate over a time period.

3. The apparatus of claim 2, wherein the time period is one of a first time period indicated in a transmission received at the UE or a second time period included in the information related to the at least one characteristic of the energy harvesting operation.

4. The apparatus of claim 2, wherein the information related to the at least one characteristic of the energy harvesting operation further comprises a battery energy level at the UE.

5. The apparatus of claim 2, wherein the at least one characteristic of the energy harvesting operation comprises an energy consumption-to-harvesting ratio (ECHR) based on an energy consumption rate and one of the harvested energy power level or the energy harvesting rate over the time period.

6. The apparatus of claim 1, wherein the information related to the at least one characteristic of the energy harvesting operation comprises a first indication of a maximum number of slots that can be scheduled in a time period based on an energy consumption-to-harvesting ratio (ECHR) threshold.

7. The apparatus of claim 6, wherein different ECHR thresholds are associated with different battery energy levels.

8. The apparatus of claim 6, wherein the first indication of the maximum number of slots that can be scheduled in the time period indicates a change in a previously-indicated maximum number of slots.

9. The apparatus of claim 6, wherein the information related to the at least one characteristic of the energy harvesting operation comprises a second indication of a behavior of the UE during time periods for which a received allocation of a number of slots in the time period exceeds the maximum number of slots that can be scheduled in the time period, and
wherein the behavior of the UE comprises one or more of disabling downlink control information (DCI) blind decoding, disabling UL transmissions, or disabling reference signal (RS) measurement and RS measurement reporting.

10. The apparatus of claim 9, wherein the second indication is included in the information related to the at least one characteristic of the energy harvesting operation in response to the received allocation of the number of slots in the time period exceeding the maximum number of slots that can be scheduled in the time period.

11. The apparatus of claim 1, wherein the at least one processor is further configured to:
activate a power saving mode of operation when at least one of:
a battery energy level at the UE is below a threshold energy level, or
an energy consumption-to-harvesting ratio (ECHR) is above a threshold value.

12. The apparatus of claim 11, wherein activating the power saving mode of operation comprises one or more of:
transitioning to a reduced capacity (RedCap) mode of operation,
transitioning from a full duplex mode of operation to a half duplex mode of operation,
reducing physical downlink control channel monitoring,
increasing a period between periodic transmissions,
disabling non-slot-based scheduling,
reducing at least one of a first number of resources in a frequency domain or a second number of resources in a time domain associated with a channel measurement operation,
reducing one of a third number of multiple input/multiple output (MIMO) or a fourth number of antenna panels associated with the wireless communication,
disabling dual connectivity,
disabling carrier aggregation,
disabling MIMO,
reducing a fifth number of neighboring cell measurements, or
disabling periodic sounding reference signal and physical uplink control channel transmission.

13. The apparatus of claim 1, wherein the information related to the at least one characteristic of the energy harvesting operation comprises an index value indicating a value in an indexed set of values for one of a harvested energy power level, an energy harvesting rate, a period of time, a battery energy level at the UE, or an energy consumption-to-harvesting ratio (ECHR).

14. The apparatus of claim 1, wherein the information related to the at least one characteristic of the energy harvesting operation comprises one of a harvested energy power level or an energy harvesting rate over a time period expressed in terms of an energy unit associated with an UL transmission.

15. The apparatus of claim 14, wherein the energy unit is based on one of a first amount of energy consumed to transmit a first number of bits or a second amount of energy consumed to transmit UL data in a second number of resource elements.

16. An apparatus for wireless communication at a network entity, comprising:
a memory; and
at least one processor coupled to the memory and, based at least in part on data stored in the memory, the at least one processor is configured to:
obtain information related to at least one characteristic of an energy harvesting operation at a user equipment (UE); and
transmit an allocation of resources for one of an uplink (UL) transmission or a downlink (DL) transmission for the UE based on the information related to the at least one characteristic of the energy harvesting operation at the UE.

17. The apparatus of claim 16, wherein the at least one characteristic comprises one of a harvested energy power level or an energy harvesting rate over a time period.

18. The apparatus of claim 17, wherein the time period is one of a first time period indicated in a transmission received at the UE or a second time period included in the information related to the at least one characteristic of the energy harvesting operation.

19. The apparatus of claim 17, wherein the information related to the at least one characteristic of the energy harvesting operation further comprises a battery energy level at the UE.

20. The apparatus of claim 17, wherein the at least one characteristic of the energy harvesting operation comprises an energy consumption-to-harvesting ratio (ECHR) based on an energy consumption rate and one of the harvested energy power level or the energy harvesting rate over the time period.

21. The apparatus of claim 16, wherein the information related to the at least one characteristic of the energy harvesting operation comprises a first indication of a maximum number of slots that can be scheduled in a time period based on an energy consumption-to-harvesting ratio (ECHR).

22. The apparatus of claim 21, wherein different ECHR thresholds are associated with different battery energy levels.

23. The apparatus of claim 21, wherein the first indication of the maximum number of slots that can be scheduled in the time period indicates a change in a previously-indicated maximum number of slots.

24. The apparatus of claim 21, wherein the information related to the at least one characteristic of the energy harvesting operation comprises a second indication of a behavior of the UE during time periods for which a received allocation of a number of slots in the time period exceeds the maximum number of slots that can be scheduled in the time period, wherein the behavior of the UE comprises one or more of disabling downlink control information (DCI) blind decoding, disabling uplink (UL) transmissions, or disabling reference signal (RS) measurement and RS measurement reporting.

25. The apparatus of claim 24, wherein the second indication is included in the information related to the at least one characteristic of the energy harvesting operation in response to the received allocation of the number of slots in the time period exceeding the maximum number of slots that can be scheduled in the time period.

26. The apparatus of claim 16, wherein the information related to the at least one characteristic of the energy harvesting operation at the UE indicates for the network entity to communicate with the UE in a power saving mode of operation, and wherein the information related to the at least one characteristic of the energy harvesting operation at the UE comprises at least one of a battery energy level at the UE being below a threshold energy level, an energy consumption-to-harvesting ratio (ECHR) being above a threshold value, or an indication of the power saving mode of operation being activated at the UE.

27. The apparatus of claim 26, wherein the power saving mode of operation comprises one or more of the UE:
transitioning to a reduced capacity (RedCap) mode of operation,
transitioning from a full duplex mode of operation to a half duplex mode of operation,
reducing physical downlink control channel monitoring,
increasing a period between periodic transmissions,
disabling non-slot-based scheduling,
reducing at least one of a first number of resources in a frequency domain or a second number of resources in a time domain associated with a channel measurement operation,
reducing one of a third number of multiple input/multiple output (MIMO) or a fourth number of antenna panels associated with the wireless communication,
disabling dual connectivity,
disabling carrier aggregation,
disabling MIMO,
reducing a fifth number of neighboring cell measurements, or
disabling periodic sounding reference signal and physical uplink control channel transmission.

28. The apparatus of claim 16, wherein the information related to the at least one characteristic of the energy harvesting operation comprises an index value indicating a value in an indexed set of values for one of a harvested energy power level, an energy harvesting rate, a period of time, an energy level of a battery of the UE, or an energy consumption-to-harvesting ratio (ECHR).

29. The apparatus of claim 16, wherein the information related to the at least one characteristic of the energy harvesting operation comprises one of a harvested energy power level or an energy harvesting rate over a period of time expressed in terms of an energy unit associated with an uplink (UL) transmission rate.

30. The apparatus of claim 29, wherein the energy unit is based on one of a first amount of energy consumed to transmit a first number of bits or a second amount of energy consumed to transmit UL data in a second number of resource elements.
